(19) United States
(12) Patent Application Publication
(10) Pub. No.: US 2025/0023311 A1
(43) Pub. Date: Jan. 16, 2025

(54) Wire-Untwisting Device

(71) Applicant: George Evans, Hanna, WY (US)

(72) Inventor: George Evans, Hanna, WY (US)

(21) Appl. No.: 18/735,278

(22) Filed: Jun. 6, 2024

Related U.S. Application Data
(60) Provisional application No. 63/512,760, filed on Jul. 10, 2023.

(51) Int. Cl. H01R 43/033

(52) U.S. Cl. CPC H01R 43/0335

(57) ABSTRACT

A wire-untwisting designed for securing and manipulating wires or cables in conjunction with a rotary tool, such as a drill. The device comprises a body with a first end featuring at least one outwardly extending male member capable of being secured within a drill's chuck, facilitating the attachment of the device to the drill. The opposite end of the body contains at least one opening from which at least one fastener extends, designed to attach to wires or cables. The device also includes a spring-loaded sheath, which can be retracted to expose the fastener for wire attachment and then released to cover the fastener, securing the wire while allowing it to extend through the sheath. Additionally, the invention can be equipped with a motor, eliminating the need for an external drill by enabling the device itself to rotate the male member.

### CROSS-REFERENCE TO RELATED APPLICATION

The present application claims priority to, and the benefit of, U.S. Provisional Application No. 63/512,760, which was filed on Jul. 10, 2023, and is incorporated herein by reference in its entirety.

### FIELD OF THE INVENTION

The present invention relates generally to the field of wiring. More specifically, the present invention relates to a wire-untwisting device that can be attached to a drill or other similar tool is easily untwist and straighten wires. Accordingly, the present disclosure makes specific reference thereto. Nonetheless, it is to be appreciated that aspects of the present invention are also equally applicable to other like applications, devices, and methods of manufacture.

### BACKGROUND

When an electrician encounters twisted wires and conductors in an electrical panel, junction box, or termination point, it is difficult to identify and connect the correct wires while also to working within a limited space. As a result, many electricians might use a drill motor to straighten the wires, thinking it saves time. However, this method can strip wire insulation or twist the conductors too much, risking injury or damage. Additionally, untwisting cables and wires by hand is time-consuming and requires effort, which can prolong projects and increase costs due to extra labor.

Therefore, there exists a long-felt need in the art for a device for twisting and untwisting wires. There also exists a long-felt need in the art for a wire-untwisting device. More specifically, there exists a long-felt need in the art for a wire-untwisting device that can be used to easily untwist and straighten wires. Further, there exists a long-felt need in the art for a wire-untwisting device that can be used to easily untwist and straighten wires wherein the device is faster and less physically demanding than doing the same by hand.

The subject matter disclosed and claimed herein, in one embodiment thereof, comprises a wire-untwisting device. The device is designed for securing and manipulating wires or cables in conjunction with a rotary tool, such as a drill. The device comprises a body with a first end featuring at least one outwardly extending male member capable of being secured within a drill's chuck, facilitating the attachment of the device to the drill. The opposite end of the body contains at least one opening from which at least one fastener extends, designed to attach to wires or cables. The device also includes a spring-loaded sheath, which can be retracted to expose the fastener for wire attachment and then released to cover the fastener, securing the wire. Additionally, the invention can be equipped with a motor, eliminating the need for an external drill by enabling the device itself to rotate the male member.

In this manner, the wire-untwisting device of the present invention accomplishes all the forgoing objectives and provides a device that can be used to easily untwist and straighten wires. Further, while doing so the device is faster and less physically demanding than doing the same by hand.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a wire-untwisting device. In one embodiment, the device is comprised of a body comprised of a first end and a second end, wherein the first end is comprised of at least one male member that extends outwards and away from the body and can be received by and secured within a chuck of a drill or other similar rotary tool.

The device is also comprised of a fastener, that is preferably a hook, that can attach to at least one wire, cable etc. To allow for attachment of a wire to the fastener, at least one spring-loaded sheath that surrounds (or may be attached to) the body can be pushed towards the first end of the body to reveal the fastener. In one embodiment, the sheath and body may be integrally formed together such that the sheath and the body can be pushed towards the male member. Once the wire is secured to the fastener, the sheath (and/or the sheath and the body in an embodiment wherein the same are integrally formed together) can be released such that the sheath slides back towards the second end and covers the fastener, further securing the wire the fastener while allowing the wire to extend from the sheath via at least one opening of the sheath. Once a wire has been attached to the device and the device has been attached to a drill wherein the drill can be used to rotate the wire clockwise or counterclockwise to twist or un-twist the wire.

The present invention is also comprised of a method of using the device. First, a device is provided comprised of a body comprised of a first end comprised of a male member and a second end comprised of a fastener, and at least one spring loaded sheath. Then, the male member can be attached to and secured within a chuck of a drill or other similar rotary tool. Next, the sheath (and/or the sheath and the body in an embodiment wherein the same are integrally formed together) can be pushed towards the first end of the body such that the fastener is exposed. Next, at least one wire can be attached to the fastener and the sheath can be released. Finally, the drill can be used to rotate the fastener clockwise or counterclockwise to twist or un-twist the wire.

Accordingly, the wire-untwisting device of the present invention is particularly advantageous as it provides a device that can be used to easily untwist and straighten wires. Further, while doing so the device is faster and less physically demanding than doing the same by hand. In this manner, the wire-untwisting device overcomes the limitations of existing methods of twisting and untwisting wires known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a wire-untwisting device of the present invention in accordance with the disclosed architecture;

FIG. 2 illustrates an enhanced perspective view of a fastener and sheath of one potential embodiment of a wire-untwisting device of the present invention in accordance with the disclosed architecture;

FIG. 3 illustrates a perspective view of one potential embodiment of a wire-untwisting device of the present invention while attached to a drill in accordance with the disclosed architecture;

FIG. 4 illustrates a flowchart of a method of using one potential embodiment of a wire-untwisting device of the present invention in accordance with the disclosed architecture; and

FIG. 5 illustrates a flowchart of a method of using one potential embodiment of a wire-untwisting device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a device for twisting and untwisting wires. There also exists a long-felt need in the art for a wire-untwisting device. More specifically, there exists a long-felt need in the art for a wire-untwisting device that can be used to easily untwist and straighten wires. Further, there exists a long-felt need in the art for a wire-untwisting device that can be used to easily untwist and straighten wires wherein the device is faster and less physically demanding than doing the same by hand.

The present invention, in one exemplary embodiment, is comprised of a wire-untwisting device. In one embodiment, the device is comprised of a body comprised of a first end and a second end. The first end is comprised of at least one male member that extends outwards and away from the body and can be received by and secured within a chuck of a drill or other similar rotary tool.

The device is also comprised of a fastener, that is preferably a hook, that can attach to at least one wire, cable etc. To allow for attachment of a wire to the fastener, at least one spring-loaded sheath that surrounds (or may be attached to) the body can be pushed towards the first end of the body to reveal the fastener. In another embodiment, the sheath and body may be integrally formed together such that the sheath and the body can be pushed towards the male member. Once the wire is secured to the fastener, the sheath (and/or the sheath and the body in an embodiment wherein the same are integrally formed together) can be released such that the sheath slides back towards the second end and covers the fastener, further securing the wire the fastener while allowing the wire to extend from the sheath via at least one opening of the sheath. Once a wire has been attached to the device and the device has been attached to a drill wherein the drill can be used to rotate the wire clockwise or counterclockwise to twist or un-twist the wire.

The present invention is also comprised of a method of using the device. First, a device is provided comprised of a body comprised of a first end comprised of a male member and a second end comprised of a fastener, and at least one spring loaded sheath. Then, the male member can be attached to and secured within a chuck of a drill or other similar rotary tool. Next, the sheath (and/or the sheath and the body in an embodiment wherein the same are integrally formed together) can be moved towards the first end of the body such that the fastener is exposed. Next, at least one wire can be attached to the fastener and the sheath can be released. Finally, the drill can be used to rotate the fastener clockwise or counterclockwise to twist or un-twist the wire.

Accordingly, the wire-untwisting device of the present invention is particularly advantageous as it provides a device that can be used to easily untwist and straighten wires. Further, while doing so the device is faster and less physically demanding than doing the same by hand. In this manner, the wire-untwisting device overcomes the limitations of existing methods of twisting and untwisting wires known in the art.

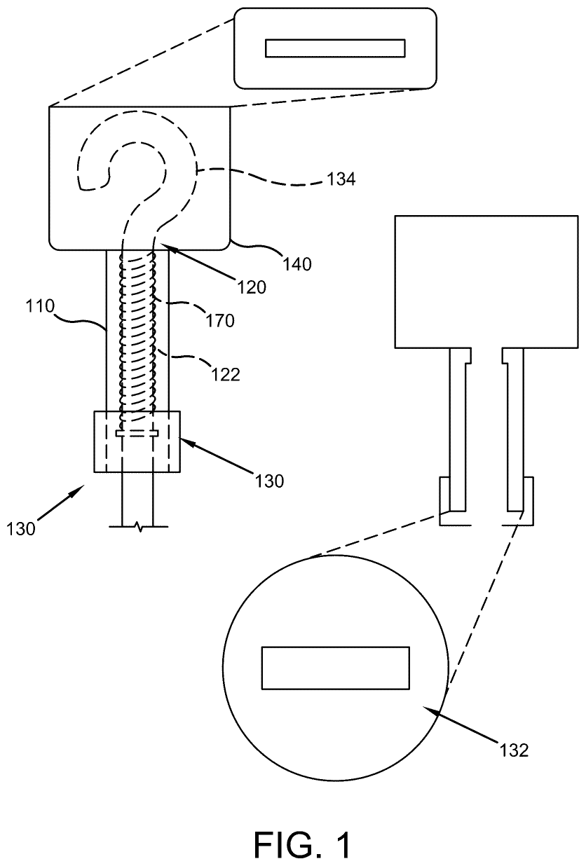

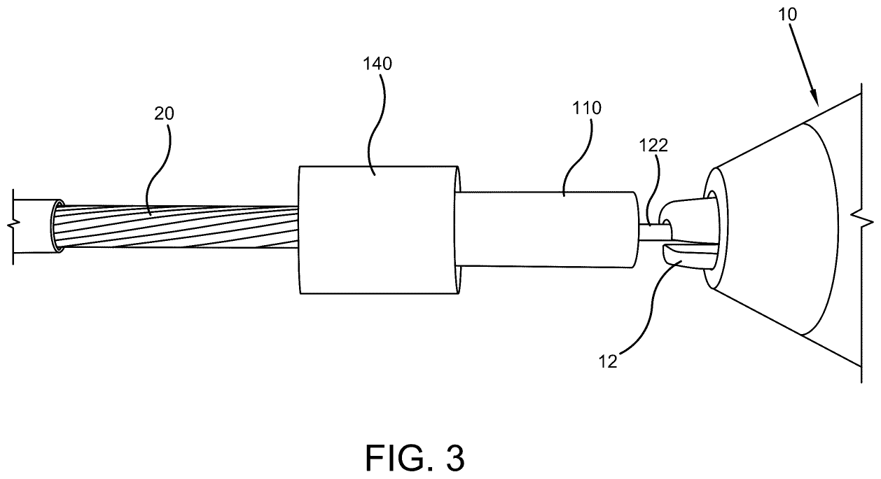

Referring initially to the drawings, FIG. 1 illustrates a perspective view of one potential embodiment of a wire-untwisting device 100 of the present invention in accordance with the disclosed architecture. In one embodiment, the device 100 is comprised of a body 110 comprised of a first end 120 and a second end 130. The first end 120 is comprised of at least one male member 122 that extends outwards and away from the body 110. The male member 122 may be fixedly or removably attached to the body 110 and/or sheath 140 and may be retained by a spring, pin, and/or spring and pin combination 170 (or other fastener of the like). The member 122 may be any size, shape, and configuration such that the member 122 can be received by and secured within a chuck 12 of a drill 10 (as seen in FIG. 3) or other similar rotary tool such as but not limited to a slotted drive-shaft (or any similar variation thereof).

The second end 130 of the body 110 is comprised of at least one opening 132. At least one fastener 134 extends outwards from the opening 132. The fastener 134 can attach to at least one wire 20, cable etc. The fastener 134 is preferably any size, shape, and configuration of hook but may be other fasteners such as but not limited to a clip, a clamp, etc. The fastener 134 may be integrally formed to the member 122 in one embodiment.

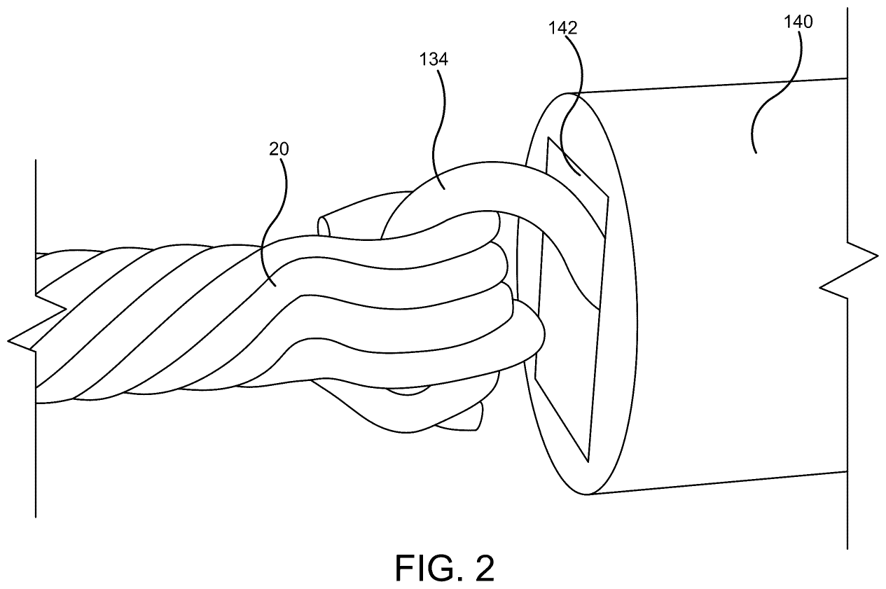

To allow for attachment of a wire 20 to the fastener 134, at least one spring-loaded sheath 140 that surrounds (or may be attached to) the body 110 can be pushed towards the first end 120 of the body 110 to reveal the fastener 134, as seen in FIG. 2. In one embodiment, the sheath 140 and body 110 may be integrally formed together such that the sheath and the body 110 can be pushed towards the male member 122. Once the wire 20 is secured to the fastener 134, the sheath 140 (and/or the sheath 140 and the body 110 in an embodiment wherein the same are integrally formed together) can be released such that the sheath 140 slides back towards the first second end 130 and covers the fastener 134, further securing the wire 20 the fastener 134 while allowing the wire 20 to extend from the sheath 140 via at least one opening 142 of the sheath 140. In one embodiment, the fastener 134 and male member 122 may be integrally formed together and may pass through an integrally formed body 110 and sheath 140. Either or both of the body 110 and sheath 140 may be tapered in one embodiment to facilitate securing of the wire 20 to the fastener 134 and to allow multiple sizes and conductor amounts to be used with the device 100.

Once a wire 20 has been attached to the device 100 and the device 100 has been attached to a drill 10 (as noted above), the drill 10 can be used to rotate the wire 20 clockwise or counterclockwise to twist or un-twist the wire 20. This eliminates the need to twist or un-twist by hand.

In one embodiment, the device 100 is instead comprised of at least one motor 150, as seen in FIG. 1. The motor 150 is preferably a 120v electric motor that spins the male member 122 in a manner similar to a drill 10. As a result, a drill 10 is not required to use the device 100. In this embodiment, the motor 150 is powered by at least one battery 152 that may be a corded battery in one embodiment. The battery 152 may be removable or non-removable and rechargeable or non-rechargeable in different embodiments. In a non-removable and rechargeable embodiment, the battery 152 can be recharged via at least one charging port 154 of any type such as but not limited to a USB port. In this embodiment, the direction of rotation that the motor 150 rotates the member 122 can be controlled via at least one button 156. In another embodiment, the motor 150 can be powered (and/or the male member 122 can be rotated) by at least one hand crank 160.

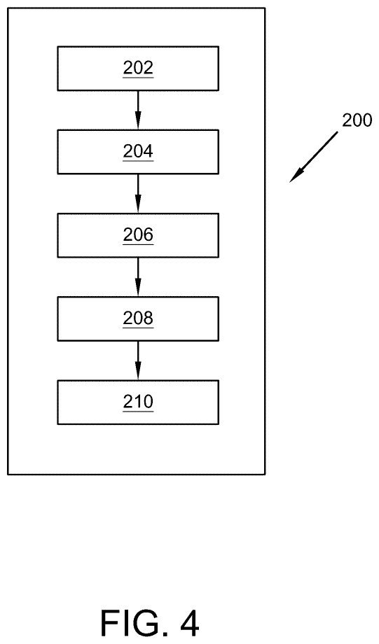

The present invention is also comprised of a method of using 200 the device 100, as seen in FIG. 4. First, a device 100 is provided comprised of a body 110 comprised of a first end 120 comprised of a male member 122 and a second end 130 comprised of a fastener 134, and at least one spring loaded sheath 140 [Step 202]. Then, the male member 122 can be attached to and secured within a chuck 12 of a drill 10 or other similar rotary tool [Step 204]. Next, the sheath 140 (and/or the sheath 140 and the body 110 in an embodiment wherein the same are integrally formed together) can be moved towards the second end 130 of the body 110 such that the fastener 134 is exposed [Step 206]. Next, at least one wire 20 can be attached to the fastener 134 and the sheath 140 can be released [Step 208]. Finally, the drill 10 can be used to rotate the fastener 134 clockwise or counterclockwise to twist or un-twist the wire 20 [Step 210].

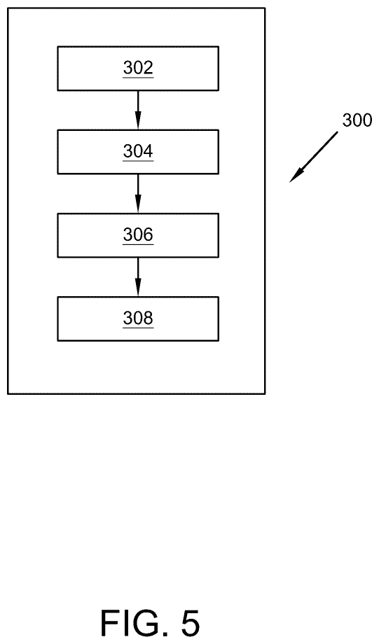

The present invention is also comprised of a method of using 300 the device 100, as seen in FIG. 5. First, a device 100 is provided comprised of a body 110 comprised of a first end 120 comprised of a male member 122 and a second end comprised of a fastener 134, at least one spring-loaded sheath 140, and at least one motor 150 [Step 302]. Then, the sheath 140 can be pushed towards the first end 120 of the body 110 such that the fastener 134 is exposed [Step 304]. Next, at least one wire 20 can be attached to the fastener 134 and the sheath 140 can be released [Step 306]. Finally, a button 156 can be pressed such that the motor 150 can be used to rotate the fastener 134 clockwise or counterclockwise to twist or un-twist the wire 20 [Step 308].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “wire-untwisting device” and “device” are interchangeable and refer to the wire-untwisting device 100 of the present invention.

Notwithstanding the forgoing, the wire-untwisting device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the wire-untwisting device 100 as shown in the FIGS. are for illustrative purposes only, and that many other sizes and shapes of the wire-untwisting device 100 are well within the scope of the present disclosure. Although the dimensions of the wire-untwisting device 100 are important design parameters for user convenience, the wire-untwisting device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A wire-untwisting device comprising:
a body;
a spring-loaded sheath attached around the body;
a fastener; and
a male member.

2. The wire-untwisting device of claim 1 further comprised of a motor that rotates the male member.

3. The wire-untwisting device of claim 2, wherein the motor is powered by a battery.

4. The wire-untwisting device of claim 3, wherein the battery is comprised of a charging port.

5. The wire-untwisting device of claim 2, wherein the motor is powered by a hand crank.

6. The wire-untwisting device of claim 1, wherein the male member is comprised of a slotted drive-shaft.

7. The wire-untwisting device of claim 1, wherein the body is comprised of a tapered body.

8. The wire-untwisting device of claim 1, wherein the sheath is comprised of a tapered sheath.

9. The wire-untwisting device of claim 1, wherein the fastener is comprised of a hook.

10. A wire-untwisting device comprising:
a body integrally formed to a spring-loaded sheath;
a fastener; and
a male member.

11. The wire-untwisting device of claim 10, further comprised of a motor that rotates the male member.

12. The wire-untwisting device of claim 11, wherein the motor is powered by a battery.

13. The wire-untwisting device of claim 12, wherein the battery is comprised of a charging port.

14. The wire-untwisting device of claim 11, wherein the motor is powered by a hand crank.

15. The wire-untwisting device of claim 10, wherein the male member is comprised of a slotted drive-shaft.

16. The wire-untwisting device of claim 10, wherein the body is comprised of a tapered body.

17. The wire-untwisting device of claim 10, wherein the sheath is comprised of a tapered sheath.

18. The wire-untwisting device of claim 10, wherein the fastener is comprised of a hook.

19. A method of using a wire-untwisting device, the method comprising the following steps:
providing a wire-untwisting device comprised of a body comprised of a male member and a fastener, and a spring-loaded sheath;
attaching and securing the male member to a chuck of a rotary tool;
pushing the spring-loaded sheath.

20. The method of using a wire-untwisting device of claim 1, wherein the male member is comprised of a slotted drive-shaft.
